(19) United States
(12) Patent Application Publication
(10) Pub. No.: US 2026/0154228 A1
(43) Pub. Date: Jun. 4, 2026

(54) CONTROL DEVICE AND CONTROL METHOD

(71) Applicant: Lenovo (Beijing) Limited, Beijing (CN)

(72) Inventors: Ning ZHANG, Beijing (CN); Xuguang GU, Beijing (CN)

(21) Appl. No.: 19/403,318

(22) Filed: Nov. 28, 2025

(30) Foreign Application Priority Data
Nov. 29, 2024 (CN) 202411745545.5

(51) Int. Cl. G06F 13/42; G06F 3/14

(52) U.S. Cl. CPC G06F 13/4282; G06F 3/14; G06F 2213/0058

(57) ABSTRACT

A first control device includes a first video processing module and a first virtual bus module. The first video processing module is connected to a first host of a controlled device. The first virtual bus module is connected to the first host of the controlled device. The first control device and a second control device are configured to perform inter-device communication. The first video processing module is configured to, in response to the first connection signal, obtain first video data from the first host and send the first video data to the primary control device. The first virtual bus module is further configured to, through communication with the second control device, obtain first control data of a second external device for the first video data from the primary control device, and to map a first virtual external device using the first control data to operate the controlled device.

### CROSS-REFERENCES TO RELATED APPLICATION

This application claims priority to Chinese Patent Application No. 202411745545.5, filed on Nov. 29, 2024, the entire content of which is incorporated herein by reference.

### FIELD OF TECHNOLOGY

The present disclosure relates to the remote control field and, more particularly, to a control device and a control method.

### BACKGROUND

With industrial electronic devices being widely used, after-sale service IT technical support for electronic devices has become increasingly important. Currently, when an electronic device malfunctions, a user usually waits until maintenance personnel arrive for repair on-site after filing a repair request or requests for remote support. The conventional remote support method includes, for example, running software on an operating system (Windows or Linux) of the electronic device, performing image collection and encoding on a screen or software image, and transmitting the encoded image to a remote terminal. A control instruction of the remote terminal is transmitted to a controlled end through a network to respond to an action event. However, an electronic device that malfunctions is normally not able to be accessed through an interface of the operating system that is network connectable. Thus, the electronic device that malfunctions is not able to be controlled by the device remotely through the software. The user needs to wait for the maintenance personnel to perform troubleshooting and repair, which leads to the downtime of the electronic device and production losses. Further, the efficiency of the malfunction handling processing of the electronic device is lowered.

### SUMMARY

One aspect of this disclosure provides a first control device, including a first video processing module and a first virtual bus module. The first video processing module is connected to a first host of a controlled device. The first virtual bus module is connected to the first host of the controlled device. The first control device and a second control device are configured to perform inter-device communication. The second control device is connected to a primary control device. The first virtual bus module is configured to obtain a first connection signal in response to a connection between the first control device and the first host. The first video processing module is configured to, in response to the first connection signal, obtain first video data from the first host and send the first video data to the primary control device. The first virtual bus module is further configured to, through communication with the second control device, obtain first control data of a second external device for the first video data from the primary control device, and to map a first virtual external device using the first control data to operate the controlled device, wherein the second external device is an external device corresponding to the primary control device.

Another aspect of this disclosure provides a second control device, including a second video processing module and a second virtual bus module. The second video processing module is connected to a second display device of a primary control device. The second virtual bus module is connected to a second external device of the primary control device. The second control device and a first control device are configured to perform inter-device communication. The first control device is connected to a controlled device. The second video processing module is configured to communicate with the first control device to obtain first video data from the controlled device for the second display device for display. The second virtual bus module is configured to obtain first control data of the second external device based on the displayed first video data and send the first control data to the first control device.

Another aspect of this disclosure provides a control method applied to a first control device. The method includes obtaining a first connection signal in response to a connection between the first control device and a first host of a controlled device, in response to the first connection signal, obtaining first video data from the first host and sending the first video data to a primary control device, obtaining first control data of a second external device for the first video data by communicating with a second control device of the primary control device, and mapping a first virtual external device using the first control data to operate a controlled device.

### BRIEF DESCRIPTION OF THE DRAWINGS

In combination with accompanying drawings and with reference to the following description of embodiments, the above and other features, advantages, and aspects of the embodiments of the present disclosure will become more apparent. Throughout the drawings, a same or similar reference number represents a same or similar element. It should be understood that the drawings are schematic and that an element is not necessarily drawn to scale.

FIG. 1 is a schematic flowchart of a repair process for an electronic device according to some embodiments of the present disclosure.

FIG. 2 is a schematic structural diagram of a first control device according to some embodiments of the present disclosure.

FIG. 3 is a schematic structural diagram of another first control device according to some embodiments of the present disclosure.

FIG. 4 is a schematic structural diagram of another first control device according to some embodiments of the present disclosure.

FIG. 5 is a schematic structural diagram of another first control device according to some embodiments of the present disclosure.

FIG. 6 is a schematic flowchart of signals of a first control device according to embodiments of the present disclosure.

FIG. 7 is a schematic structural diagram of a second control device according to some embodiments of the present disclosure.

FIG. 8 is a schematic structural diagram of another second control device according to some embodiments of the present disclosure.

FIG. 9 is a schematic structural diagram of another second control device according to some embodiments of the present disclosure.

FIG. 10 is a schematic flowchart of signals of a second control device according to embodiments of the present disclosure.

FIG. 11 is a schematic flowchart of a control method according to embodiments of the present disclosure.

FIG. 12 is a schematic flowchart of processing an error of a computer according to embodiments of the present disclosure.

FIG. 13 is a schematic structural diagram of a first control device and a second control device according to embodiments of the present disclosure.

FIG. 14 is a schematic diagram of a hardware entity of a first control device according to embodiments of the present disclosure.

FIG. 15 is a schematic diagram of a hardware entity of a second control device according to embodiments of the present disclosure.

### DETAILED DESCRIPTION

To make the objectives, technical solutions, and advantages of the present disclosure clearer, the technical solutions of the present disclosure are described in connection with the accompanying drawings and embodiments of the present disclosure. The embodiments described should not be regarded as limitations on the present disclosure. All other embodiments obtained by those of ordinary skill in the art without creative effort shall fall within the scope of the present disclosure.

In the following description, “some embodiments” describe a subset of all possible embodiments. However, “some embodiments” may represent the same or different subsets of all possible embodiments, which can be combined with each other as long as there is no conflict.

The terms “first,” “second,” and “third” in embodiments of the present disclosure are only used to distinguish similar objects and do not indicate any specific order of the objects. “First,” “second,” and “third” may be interchanged where appropriate, so that embodiments of the present disclosure described herein may be implemented in an order different from the order illustrated or described.

Those skilled in the art can understand that, unless otherwise defined, all the terms used here (including technical and scientific terms) have the same meanings as commonly understood by those of ordinary skill in the art. Terms defined in general dictionaries should be interpreted as having meanings consistent with the context of the existing technology and are not to be interpreted in an idealized or overly formal sense unless specifically defined herein.

In related technologies, the main method of after-sale service support or IT technical support for electronic devices are as follows. After an electronic device malfunctions, the user can submit a repair request. When the repair request is received, and if the system or hardware is determined to have problems, technical support personnel can be dispatched to perform on-site troubleshooting. After the technical personnel determine the cause of the malfunction, the technical personnel can perform corresponding repair measures. A conventional electronic device repair request processing flowchart is shown in FIG. 1. First, a repair request is reported. Then, the technical personnel accept the repair request. The technical personnel determine whether the malfunction is caused by software. If the software causes the problem, the technical personnel guide the operation or remotely assist to eliminate the malfunction. If the software does not cause the problem, the maintenance personnel go on-site for processing. The maintenance personnel adjust to solve the configuration problem or replace a hardware device for the malfunction of the hardware device to eliminate the malfunction. The cause of the malfunction for the electronic device can include software malfunction, system malfunction, software or system configuration, BIOS configuration or version mismatch, and hardware device damage. The electronic device malfunction caused by software can include, e.g., network failures preventing Internet access, or system boot failures due to BIOS settings or system configuration errors rather than hardware issues. The malfunction of the electronic product can be processed by merely controlling the electronic device remotely. Only in cases of hardware device damage, an engineer must visit the site to replace the hardware device for inspection and repair.

The current conventional remote control method can include running software on an operating system (e.g., Windows or Linux) installed on the electronic device, performing the image collection on the screen or software images, and encoding and transmitting the collected image to the remote terminal. The control instruction of the remote terminal can be transmitted to the controlled end for action and event response through the network. However, since the electronic device with malfunctions cannot enter the system accessible to networks, the method of remotely controlling the device through the software cannot function properly.

The control device and control method of embodiments of the present disclosure are described exemplarily in connection with the accompanying drawings of embodiments of the present disclosure.

In embodiments of the present disclosure, the controlled device can be a device that has a malfunction. That is, the controlled device can be a device that needs to be remotely controlled to solve the malfunction. The controlled device can be remotely controlled by a primary control device. The primary control device can be configured to perform remote troubleshooting and malfunction processing on the controlled device to eliminate the malfunction of the controlled device. A first control device and a second control device can be control devices configured to realize the remote control between the controlled device and the primary control device. The relationship between the connection method of the first control device and the second control device and the connected devices can be as follows. The first control device can be connected in series between a first display device and a first host of the controlled device. The second control device can be connected in series to the primary control device. The first control device can be configured to simulate interface terminals such as USB, serial ports, and RS485 to map the related information of the controlled device to the second control device of the primary control device to realize the remote control.

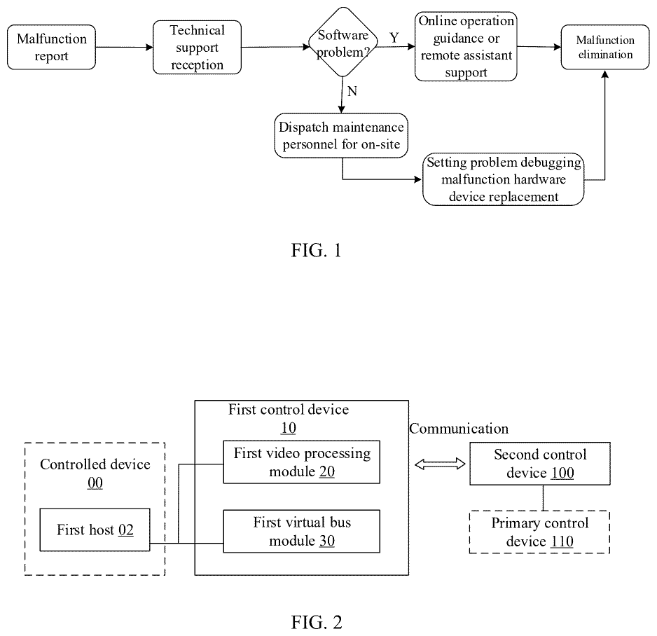

FIG. 2 is a schematic structural diagram of the first control device according to some embodiments of the present disclosure. The first control device includes a first video processing module and a first virtual bus module.

The first video processing module is connected to the first host of the controlled device. The first virtual bus module is connected to the first host of the controlled device. The first control device can communicate with the second control device. The second control device can be connected to the primary control device.

The first virtual bus module can be configured to obtain a first connection signal in response to the connection between the first control device and the first host.

The video processing module can be configured to obtain and send the first video data from the first host to the primary control device in response to the first connection signal.

The first virtual bus module can be further configured to obtain first control data of a second external device for the first video data from the primary control device through the communication with the second control device, and map the first virtual external device using the first control data to operate the controlled device. The second external device is an external device corresponding to the primary control device.

In embodiments of the present disclosure, the first control device can be configured to control the controlled device for remote control. In some embodiments, the first control device can be used with the second control device to allow the controlled device to be remotely controlled by the primary control device. The primary control device can be configured to perform remote troubleshooting and processing to eliminate the malfunction of the controlled device.

In embodiments of the present disclosure, when the first control device is connected to the first host of the controlled device, e.g., the first control device is inserted into the first host, the controlled device can generate the first connection signal. According to the first connection signal, the controlled device and the first control device can start the interaction of the remote control.

In embodiments of the present disclosure, the first control device can include the first video processing module. According to the first connection signal, the first video processing module can obtain the first video data from the first host and send the first video data to the primary control device. The first video data can be malfunction video data of the controlled device. The purpose of sending the first video data to the primary control device can include allowing the primary control device to obtain the malfunction data of the controlled device to recognize the cause of the malfunction and perform troubleshooting.

In embodiments of the present disclosure, the second control device can be configured to allow the primary control device and the controlled device to perform the remote control. The second control device can include the first virtual bus module. The first virtual bus module can be configured for the communication of the second control device.

In some embodiments, after obtaining the first video data (malfunction data) of the controlled device, the primary control device can be configured to process the first video data using the second external device, such as mouses and keyboards. The operation data generated in the processing process can be the first control data.

In embodiments of the present disclosure, since the first host of the controlled device is not directly connected to the external device, and is connected to the external device through the first control device, the first virtual bus module may need to map the first virtual external device using the first control data. Then, the mapped first virtual external device can be configured to operate the controlled device. That is, the malfunction processing operation of the primary control device can be remotely synchronized to the controlled device to realize the remote malfunction processing for the controlled device.

In some embodiments, with a plurality of general video input/output interface, a general data input/output interface such as USB and serial port, wired or wireless network communication functions, module connection functions such as an integrated virtual video bus, virtual audio card bus, virtual USB bus, and virtual external bus, the situation that no remote access can be provided with system malfunction, software malfunction, and non-hardware damage can be compensated.

When the first control device performs remote control and malfunction processing on the controlled device, the first control device may only need to be connected to the controlled device. After the first connection signal is generated, the first control device can start to perform the remote-assisted debugging and malfunction processing on the controlled device. The first control device can obtain the first video data from the first host and send the first video data to the primary control device. The first control device can obtain the first control data of the second external device for the first video data and map the first virtual external device using the first control data to operate the controlled device. Thus, through the first control device, the malfunction of the controlled device can be remotely processed on the primary control device. The controlled device can be remotely controlled to eliminate the malfunction, which avoids the time for the IT support personnel to arrive on-site. Thus, the problem can be quickly determined and solved, the speed to solve the problem of the controlled device can be improved, and the production loss and downtime due to device malfunction or problem detection can be reduced, thereby improving the efficiency of the malfunction processing for the controlled device.

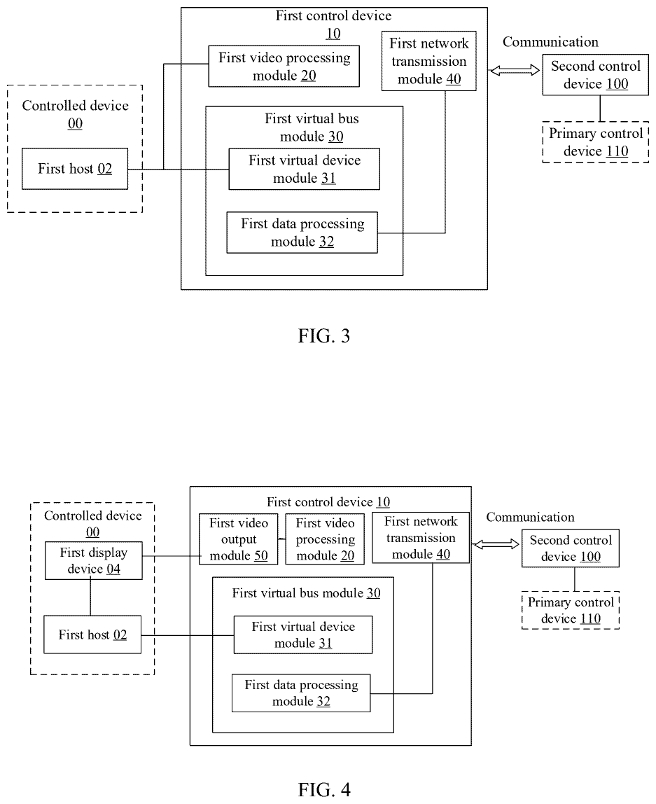

In some embodiments, FIG. 3 illustrates a schematic structural diagram of the first control device 10. The first control device 10 includes a first network transmission module 40. The first virtual bus module 30 includes a first virtual device module 31 and a first data processing module 32. The first virtual device module 31 is connected to the first host 02. The first data processing module 32 is connected to the first network transmission module 40.

The first data processing module 32 can be configured to obtain the first control data of the second external device for the first video data from the primary control device 110 through the first network transmission module 40, parsing the first control data to obtain the descriptor of the second external device, and transmit the descriptor of the second external device to the first virtual device module 31.

The first virtual device module 31 can be configured to map the first virtual external device using the descriptor of the second external device, and transmit the control instruction to the first host 02 of the controlled device 00 based on the first virtual external device to control and operate the controlled device 00.

In embodiments of the present disclosure, the first network transmission module 40 can be configured for the network transmission of the data between the controlled device 00 and the primary control device 110. The first control data can be transmitted from the primary control device 110 to the first data processing module 32 of the controlled device 00 through the first network transmission module 40.

In embodiments of the present disclosure, after obtaining the first control data of the second external device of the primary control device 110 and parsing the first control data, the first data processing module 32 can obtain the data indicating the operation behavior of the second external device, and transmit the data as the descriptor to the first virtual device module 31. That is, the operation data generated from the primary control device 110 performing the malfunction processing (the first control data generated by the second external device) can be fed back to the first data processing module 32 of the controlled device 00 through the first network module. The first data processing module 32 can parse the operation data to obtain the data (descriptor) of the malfunction processing and control the controlled device 00 according to the descriptor to realize the malfunction processing of the controlled device 00.

The data transmission between the controlled device and the primary control device can be realized through the first network transmission module of the first control device. The type of the controlled device and the system operation status may not be limited, and the network status of the controlled device may not be limited to effectively improve the adaptability and flexibility of the controlled device in the remote control. Moreover, the first control data of the primary control device can be transmitted to the controlled device using the first network transmission module to control the controlled device remotely. Thus, the timeliness of the malfunction processing of the controlled device can be improved.

In some embodiments, as shown in FIG. 4, the first control device 10 further includes a first video output module 50. The first display device 04 of the controlled device 00 is connected to the first video output module 50. The first video output module 50 is connected to the first video processing module 20.

The first video output module 50 can be configured to obtain the first video data from the first video processing module 20 and transmit the first video data to the first display device 04.

The first video processing module 20 can be further configured to receive the first display data sent by the primary control device through the first network transmission module and transmit the first display data to the first video output module 50.

The first video output module 50 can be further configured to transmit the first display data to the first display device 04. Then, the first display device 04 can combine the first video data and the first display data for display.

In embodiments of the present disclosure, the first video processing module 20 can output the first video data (the malfunction video data of the controlled device 00) to the first video output module 50. The first video output module 50 can be connected to the first display device 04 of the controlled device 00 and transmit the first video data to the first display device 04 for display.

In some embodiments, the first display data can be data such as a watermark, a remote canvas, or remote assistance guidance displayed when the primary control device performs the malfunction processing.

In embodiments of the present disclosure, the first video processing module 20 can receive the first display data transmitted by the primary control device through the first network transmission module and transmit the first display data to the first video output module 50. The first video output module 50 can transmit the first display data to the first display device 04 for display. That is, the data displayed on the first display device 04 can include first display data and first video data. The content displayed on the first display device 04 can include the content after combining the first video data and the first display data.

In embodiments of the present disclosure, when the first control device 10 is applied, the first control device 10 can be connected in serial between the first display device 40 and the first host 02. Then, the first control device 10 can be mapped to the primary control device 110 to realize the remote control by simulating the interface terminal such as USB, serial port, and RS485.

On one aspect, the first video data (the malfunction video data) of the controlled device can be combined with the first display data of the primary control device to be displayed on the first display device of the controlled device. Thus, the first display device can display the content that the controlled device is remotely controlled to perform the malfunction processing. Thus, the visibility of the remote control of the controlled device can be enhanced. On another aspect, the first control device can merely be connected in serial between the first display device and the first host. That is, the use of the first control device may not impact the connections between other devices of the controlled device.

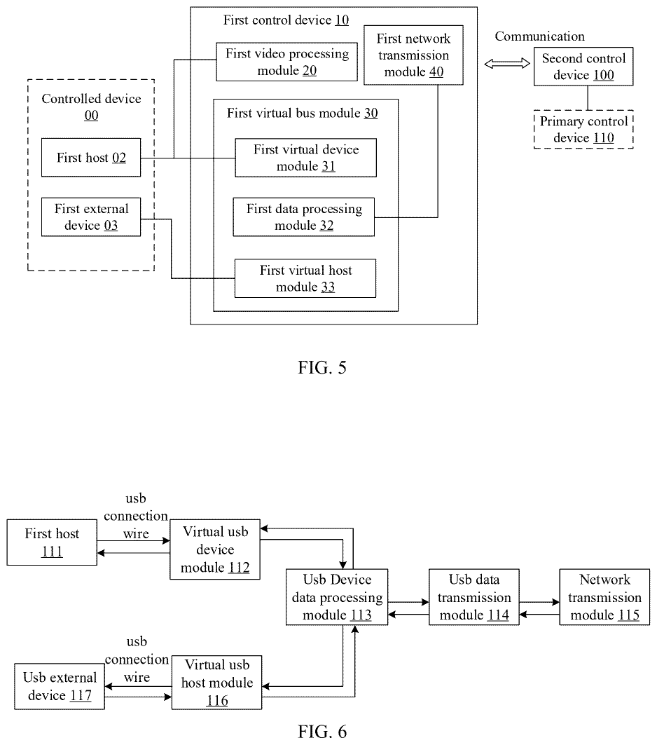

In some embodiments, FIG. 5 illustrates a schematic structural diagram of the first control device 10. The first virtual bus module 30 includes a first virtual host module 33. The first virtual host module 33 is connected to the first external device 03 of the first control device 10.

The first virtual host module 33 can be configured to obtain the second control data of the first external device 03 and transmit the second control data to the first virtual device module 31 of the first virtual bus module 30.

The first virtual device module 31 can be configured to map the second virtual external device using the second control data to operate the controlled device 00.

In embodiments of the present disclosure, since the first external device 03 of the controlled device 00, e.g., mouse, keyboard, etc., is not directly connected to the first host 02, the first virtual host module 33 can be connected to the first external device 03, and the first virtual device module 31 may need to be connected to the first machine 02.

In embodiments of the present disclosure, the second control data can be the control data generated when the first external device 03 of the controlled device 00 is used. The second control data can be obtained using the first virtual device module 31. The second control data can be transmitted to the first virtual device module 31 of the first virtual bus module 30.

In embodiments of the present disclosure, after obtaining the second control data, the first virtual device module 31 can map the second virtual external device using the second control data to operate the controlled device 00.

In some embodiments, as shown in FIG. 6, the first host 111 of the controlled device is connected to the virtual USB device module 112 (the first virtual device module). The USB external device 117 is connected to the virtual USB host module 116 (the first virtual host module). The virtual USB device module 112 and the virtual USB host module 116 are connected to the USB device (the first external device) data processing module 113. The USB data transmission module 114 is connected to the network transmission module 115. When the USB external device 117 (the first external device) is connected to the present device, the virtual USB device will copy the USB descriptor of the USB external device 117 and virtualize the same device for connection. Then, the USB signal such as the control signal of the first host 111 is forwarded to the USB external device 117. The data signal returned by the USB external device 117 is also forwarded to the first host 111.

The first virtual bus module can include the first virtual device module and the first virtual host module. The first external device can control the controlled device through the first virtual bus module. The feasibility of the first control device controlling the first external device of the controlled device can be improved.

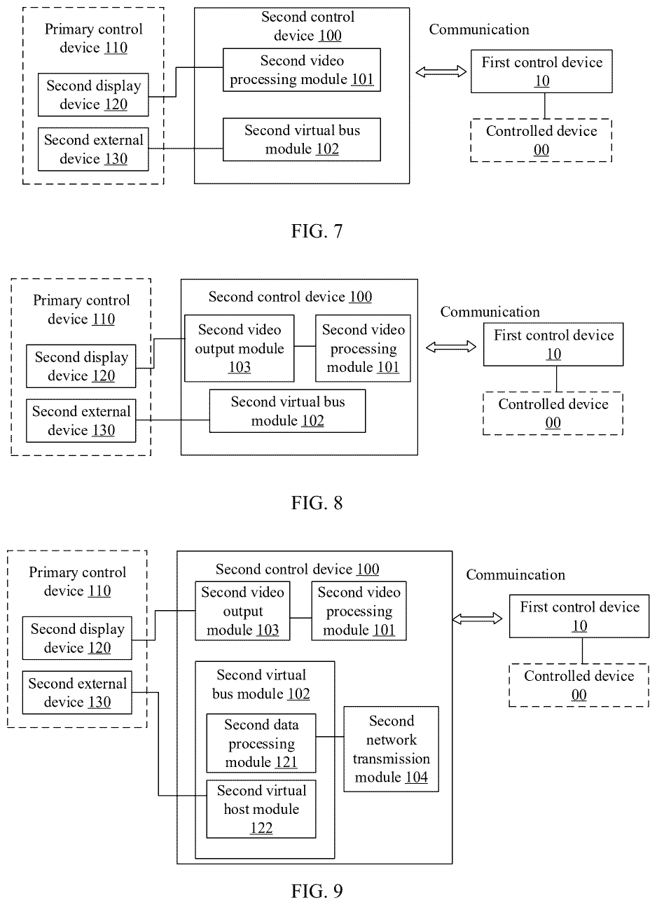

FIG. 7 illustrates a schematic structural diagram of the second control device 100 of embodiments of the present disclosure. The second control device 100 includes a second video processing module 101 and a second virtual bus module 102. The second video processing module 101 is connected to the second display device 120 of the primary control device 110. The second virtual bus module 102 is connected to the second external device 130 of the primary control device 110. The second control device 100 and the first control device 10 can realize the communication between devices. The first control device 10 is connected to the controlled device 00.

The second video processing module 10 can be configured to communicate with the first control device 10 to obtain the first video data from the controlled device 00 for the second display device 120 to display.

The second virtual bus module 102 can be configured to obtain the first control data of the second external device 130 based on the displayed first video data and send the first control data to the first control device 10.

In embodiments of the present disclosure, the second control device 100 can be a device for controlling the primary control device 110, and the second control device 100 can be the control device corresponding to the first control device 10. Through the data transmission between the second control device 100 and the first control device 10, the primary control device 110 can control the controlled device 00 remotely.

In embodiments of the present disclosure, the second control device 100 can include the second video processing module 101 and the second virtual bus module 102. The second video processing module 101 of the second control device 100 can obtain the first video data of the controlled device 00. After the first video data is transmitted by the second virtual bus module 102, the first video data can be displayed on the second display device 120 of the primary control device 110.

In embodiments of the present disclosure, the second external device 130 can include a keyboard, mouse, USB collector, etc.

In embodiments of the present disclosure, the first video data can be displayed on the primary control device 110. The second external device 130 of the primary control device 110 can perform control on the first video data to generate the first control data. The second virtual bus module 102 of the primary control device 110 can obtain the first control data and send the first control data to the first control device 10 of the controlled device 00.

The second control device of the primary control device can receive and display the first video data of the controlled device. The primary control device can control the first video data using the second external device to generate the first control data and send the first control data to the controlled device using the second virtual bus module. Thus, the effectiveness of the remote control between the primary control device and the controlled device can be realized.

In some embodiments, as shown in FIG. 8, the second video processing module 101 is further configured to collect first display data from the second display device 120 and send the first display data to the first control device 10.

The second control device 100 further includes a second video output module 103. The second display device 120 is connected to the second video output module 103. The second video output module 103 is connected to the second video processing module 101.

The second video output module 103 can be configured to obtain the first video data from the second video processing module 101 and transmit the first video data to the second display device 120.

In embodiments of the present disclosure, the first display data can be related data of the remote control collected by the second display device 120, such as related data of a watermark or remote canvas.

In embodiments of the present disclosure, the second control device 100 of the primary control device can include the second video output module 103 and the second video processing module 101. The first video data obtained by the second video processing module 101 can be transmitted to the second video output module 103. The second video output module 103 can then transmit the first video data to the second display device 120 for display.

The first video data can be transmitted using the second video output module and the second video processing module to allow the first video data to be displayed on the second display device. The first display data can be transmitted using the second video output module and the second video processing module to allow the first display data to be transmitted to the controlled device by the primary control device to ensure the feasibility and effectiveness of the video data transmission between the primary control device and the controlled device.

In some embodiments, as shown in FIG. 9, the second control device 100 includes a second network transmission module 104. The second virtual bus module 102 includes a second data processing module 121 and a second virtual host module 122. The second data processing module 121 is connected to the second network transmission module 104. The second virtual host module 122 is connected to the second external device 130.

The second virtual host module 122 can be configured to obtain the first control data of the second external device 130 and transmit the first control data to the second data processing module 121.

The second data processing module 121 can be configured to encode the first control data and send the encoded first control data to the first control device 10 via the second network transmission module 104.

In embodiments of the present disclosure, firstly, the first control data of the second external device 130 can be transmitted to the second data processing module 121 through the second virtual host module 122. Secondly, the second data processing module 121 can encode the first control data and transmit the encoded first control data to the first control device 10 via the second network transmission module 104.

In some embodiments, the USB device (the second external device) of the second host of the primary control device can be connected to a USB collection module. The USB collection module and the USB mapping module (the second virtual device module) can be connected to a USB device data processing module. The USB data transmission module can be connected to the network transmission module. When the second external device of the primary control device needs to be mapped to the controlled device, the second external device of the second host of the controlled device can collect the USB device data through the USB collection module. The USB device data can be converted into transferable USB data (the first control data) by the USB processing module. The transferable USB data can be transmitted to the controlled device through the USB transmission module and the network transmission module.

In this scheme, the interconnection and intercommunication between the primary control device and the controlled device can be realized through the second virtual bus module. The first control data of the primary control device can be transmitted to the controlled device by the second network transmission module to remotely control the controlled device. Thus, the effectiveness of the remote communication and control between the primary control device and the controlled device can be improved.

In some embodiments, the second virtual bus module can further include a second virtual device module. The second virtual host module can be further configured to transmit the first control data to the second virtual device module.

The second virtual device module can be configured to, based on the first control data, map a third virtual external device, and display the operation of the third virtual external device in real-time on the second display device for use when the second video processing module collects the display data.

In embodiments of the present disclosure, firstly, the second virtual host module can transmit the first control data to the second virtual device module. Secondly, the second virtual device module can map the third virtual external device using the first control data. Then, the second virtual device module can display the operation of the third virtual external device in real time on the second display device.

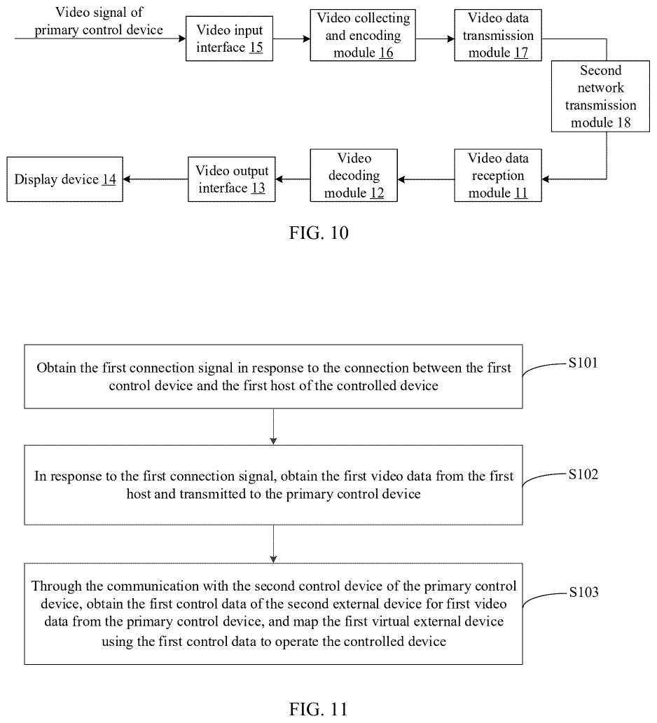

In some embodiments, FIG. 10 illustrates the data flow of the second virtual bus of the primary control device. After the video signal of the primary control device receives the first video data via the video data reception module 11, the video decoding module 12 can be configured to parse the first video data. The display image can be output by a standard video output interface 13 through the video playback module. The video output interface 13 can be a physical monitor 14, a virtual display device 14, or a software video image. When the first display data of the functions such as watermark/remote assistant instructions needs to be added, the processing of transmitting the first display data of the primary control device to the video collection and encoding module 16 via the video input interface 15 can be transmitted to the video data transmission module 17 and to the controlled device via the second network transmission module 18.

The second virtual host module can send the first control data to the second virtual device module. The second virtual device module can map the third virtual external device using the first control data. The second virtual device module can display the operation of the third virtual external device in real time on the second display device. Thus, the second display device of the primary control device can display the operation in real-time of the third virtual connection device to improve the visibility of the primary control device.

This realizes the display of the real-time operation screen of the third virtual external device on the second display device of the primary control device, thereby improving the visibility of the primary control device.

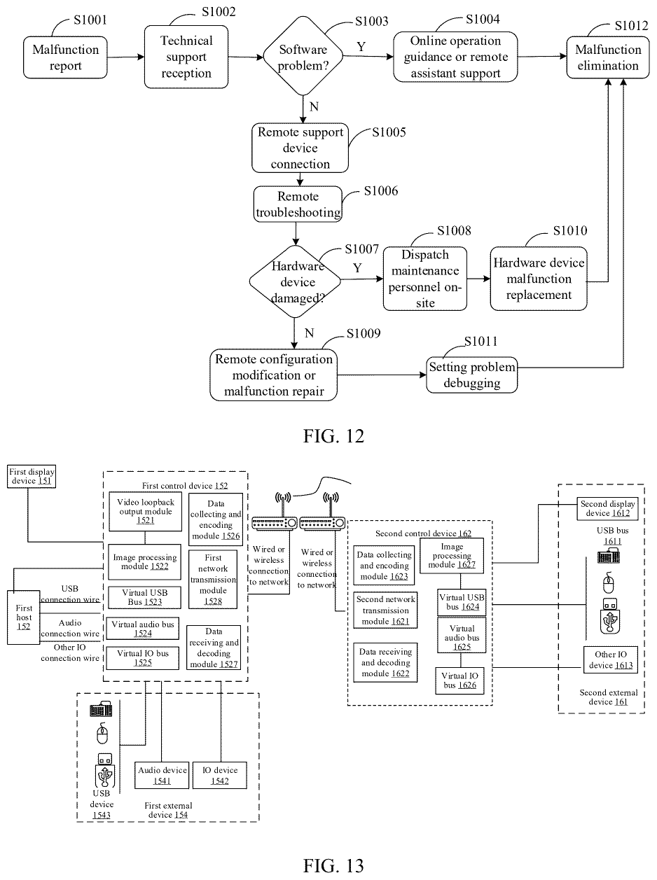

Embodiments of the present disclosure provide a control method applied to the first control device. FIG. 11 illustrates a schematic flowchart of the method. The control method includes S101 to S103.
At S101, the first connection signal is obtained in response to the connection between the first control device and the first host of the controlled device.
At S102, in response to the first connection signal, the first video data is obtained from the first host and transmitted to the primary control device.
At S103, through the communication with the second control device of the primary control device, the first control data of the second external device for the first video data is obtained from the primary control device. The first virtual external device can be mapped using the first control data to operate the controlled device.

In embodiments of the present disclosure, when the controlled device malfunctions and needs remote troubleshooting, the first control device can be connected to the first host of the controlled device. After the connection is successful, the first control device can obtain the first connection signal.

In embodiments of the present disclosure, the first control device can, in response to the first connection signal, obtain the first video data (the data related to the malfunction of the controlled device) from the first host and send the first video data to the primary control device.

In embodiments of the present disclosure, the first control device can communicate with the second control device of the primary control device. The first control data of the second external device for the first video data can be obtained from the primary control device. The first virtual external device can be mapped using the first control data to operate the controlled device.

When the first control device performs remote control and malfunction processing on the controlled device, the first control device may only need to be connected to the controlled device. After the first connection signal is generated, the first control device can start to assist debugging and malfunction processing remotely. The first control device can obtain the first control data of the second external device for the first video data from the primary control device and map the first virtual external device using the first control data to operate the controlled device. With the first control device, the malfunction of the controlled device can be processed remotely on the primary control device, and the controlled device can be controlled remotely to finish malfunction elimination, which avoids the time for waiting for the IT support personnel to arrive on-site. Thus, the problem can be quickly determined and solved to improve the speed of solving the problem of the controlled device and reduce the production loss and downtime due to the device malfunction or troubleshooting. Then, the efficiency of the malfunction processing of the controlled device can be improved.

In some embodiments, step S103 includes steps S201 to S203.
At S201, through the communication with the second control device of the primary control device, the first control device of the second external device for the first video data is obtained from the primary control device.
At S202, the first control data is parsed to obtain the descriptor of the second external device.
At S203, the first virtual external device is mapped using the descriptor of the second external device. The control instruction is transmitted to the first host of the controlled device based on the first virtual external device to control and operate the controlled device.

In embodiments of the present disclosure, the first control data can be control data of the second external device of the primary control device for performing malfunction processing on the first video data.

In embodiments of the present disclosure, the first control device of the controlled device can communicate with the second control device of the primary control device to obtain the first control data of the primary control device.

In embodiments of the present disclosure, after obtaining the first control data, the controlled device can parse the first control data to obtain the descriptor of the second external device. The first control device can map the first virtual external device using the descriptor of the second external device and transmit the control instruction to the first host of the controlled device based on the first virtual external device to control and operate the controlled device.

The data transmission between the controlled device and the primary control device can be realized using the first network transmission module of the first control device. The system type and system operating status of the controlled device are not limited. The network status of the controlled device is not limited. The adaptability and the flexibility of remote control can be effectively improved. The first network transmission module can be configured to transmit the first control data of the primary control device to the controlled device to control the controlled device remotely. Thus, the timeliness of the malfunction processing of the controlled device can be improved.

The first control device, the second control device, and the control method of the first control device are described in detail in connection with embodiments of the present disclosure. The embodiments of the present disclosure can be used to better describe the present disclosure but do not create an inappropriate limitation for the present disclosure.

Exemplary application of embodiments of the present disclosure in an actual application scenario is described in detail below.

FIG. 12 illustrates a schematic flowchart of malfunction processing when a computer has malfunctions. The malfunction processing includes steps S1001 to S1012.
At S1001, malfunction is reported.
At S1002, technical support accepts the malfunction report.
At S1003, whether the software has a problem is determined. If yes, proceed to S1004, and if no, proceed to S1005.
At S1004, online guidance operation or remote assistant support is provided.
At S1005, the remote support device is connected.
At S1006, troubleshooting is performed remotely.
At S1007, whether a hardware device is damaged is determined. If yes, proceed to S1008, and if no, proceed to S1009.
At S1008, a repair personnel is dispatched to go on-site for repair.
At S1010, the hardware device with a malfunction is replaced.
At S1009, the configuration is modified remotely, or the malfunction is repaired.
At S1011, the setting problem is adjusted and solved.
At S1012, the malfunction is eliminated.

In embodiments of the present disclosure, for the software problem in the computer, the first control device and the second control device of embodiments of the present disclosure can be adopted to perform the remote malfunction processing.

In embodiments of the present disclosure, as shown in FIG. 13, the controlled device includes a first display 151, a first control device 152, a first host 153, and a first external device 154 (e.g., an audio device 1541, an I/O device 1542, and a USB device 1543). The primary control device includes a second external device 161 (e.g., a general-purpose USB device 1611, a second display device 1612, and a general-purpose I/O device 1613) and a second control device 162.

In embodiments of the present disclosure, the first control device includes a video loopback output module 1521, an image processing module 1522, a first virtual bus module (e.g., a virtual USB bus 1523, a virtual audio bus 1524, and a virtual I/O bus 1525), a data receiving and decoding module 1526, a data collecting and encoding module 1527 (e.g., the first video processing module including the data receiving and decoding module and the data collecting and encoding module), and a first network transmission module 1528.

In embodiments of the present disclosure, the second control device 162 includes a second network transmission module 1621, a data receiving and decoding module 1622, a data collecting and encoding module 1623 (e.g., the second video processing module including the data receiving and decoding module and the data collecting and encoding module), and a second virtual bus module (e.g., a virtual USB bus 1624, a virtual audio bus 1625, and a virtual I/O bus 1626).

In embodiments of the present disclosure, when the controlled device needs to be remotely debugged for malfunction processing, the controlled device can be connected to the first control device 152. The data collecting and encoding module 15 of the first control device 152 can be configured to transmit the malfunction data (i.e., the first video data) of the controlled device to the second control device 162. After the transmission image processing module 1627 is processed by the data receiving and decoding module 1622 of the second control device 162, the image processing module 1627 can be transmitted to the second display device 1612 for display.

In embodiments of the present disclosure, after the primary control device receives the first video data and displays the first video data on the second display device 1612, the second control device 162 can collect the first control data of the second external device 161. The first control data can be generated by the second external device 161 controlling the first video data. The second control device 161 can transmit the first control data to the controlled device through the second network transmission module 1621. The controlled device can process the first control data through the data receiving and decoding module 1527 and simulate the USB device (i.e., descriptor) through the first virtual device of the first virtual bus module. The descriptor can be sent to the first host to control the controlled device.

In embodiments of the present disclosure, the display content on the first display device 151 of the controlled device can include the first video data, and the display content (i.e., the first display data) on the second display device 1612 such as the watermark/remote assistant guidance and remote canvas sent by the primary control device. The first display device can display in a plurality of windows. For example, the real-time video data, watermark window, and canvas window of the controlled device can be displayed.

In embodiments of the present disclosure, when the first control device performs remote control and malfunction processing for the controlled device, the first control device may only need to be connected to the controlled device. After the first connection signal is generated, the first control device can start to assist in debugging and malfunction processing remotely on the controlled device. The first control device can obtain the first video data from the first host and send the first video data to the primary control device. The first control device can obtain the first control data of the second external device for the first video data from the primary control device and map the first virtual external device using the first control data to operate the controlled device. The malfunction of the controlled device can be processed remotely on the primary control device through the first control device and control the controlled device remotely to eliminate the malfunction, which avoids the time to wait for the IT support personnel to arrive on-site to allow the problem to be quickly determined and solved. Thus, the speed for solving the problem of the controlled device can be improved, and the production loss and downtime due to the malfunction of the controlled device or troubleshooting can be reduced. Further, the efficiency of the malfunction processing of the controlled device can be improved.

In embodiments of the present disclosure, if the method is implemented in the form of a software functional module and is sold or used as an individual product, the software functional module can be stored in a computer-readable storage medium. Based on this understanding, the essence of the technical solution or the part contributing to the related technology of embodiments of the present disclosure can be embodied in the form of a software product. The software product can be stored in a storage medium and include a plurality of instructions used to cause a computer device (e.g., a personal computer, a server, a network device, etc.) to execute all or a part of the steps of the method of embodiments of the present disclosure. The above storage medium can include various media that can store program codes, such as USB flash drives, portable hard drives, Read-Only Memory (ROM), magnetic disks, or optical disks. Therefore, embodiments of the present disclosure are not limited to any specific hardware, software, or firmware, or a combination thereof.

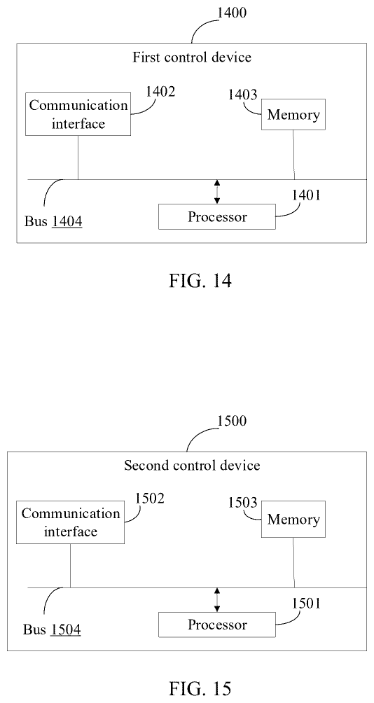

Embodiments of the present disclosure provide a first control device 1400. As shown in FIG. 14, hardware entities of the first control device 1400 include a processor 1401 and a memory 1403. The memory can store a computer program executable on the processor that, when executed by the processor, causes the processor to implement the steps in the control method of the first control device.

The processor 1401 can generally control the overall operation of the first control device 1400. The memory 1403 can be configured to store instructions and applications executable by the processor 1401 and also buffer data to be processed or already processed by the processor 1401 and various modules of the first control device 1400 (e.g., image data, audio data, voice communication data, and video communication data). The memory 1403 can include flash memory (FLASH) or Random Access Memory (RAM). The first control device can further include a communication interface 1402. The communication interface 1402 can allow the first control device to communicate with other terminals or servers through a network. Data transmission among the processor 1401, the communication interface 1402, and the memory 1403 can be performed through a bus 1404.

Embodiments of the present disclosure provide a second control device 1500. As shown in FIG. 15, hardware entities of the second control device 1500 include a processor 1501 and a memory 1503. The memory can store a computer program executable on the processor that, and when executed by the processor, causes the processor to implement the steps in the control method of the second control device.

The processor 1501 can generally control the overall operation of the second control device 1500. The memory 1503 can be configured to store instructions and applications executable by the processor 1501, and can also cache data (e.g., image data, audio data, voice communication data, and video communication data) to be processed or already processed by the processor 1501 and various modules in the second control device 1500. The memory 1503 can include flash memory (FLASH) or random access memory (RAM). The second control device can further include a communication interface 1502. The communication interface 1502 can allow the second control device to communicate with other terminals or servers through a network. Data transmission among the processor 1501, the communication interface 1502, and the memory 1503 can be performed through a bus 1504.

Based on the above embodiments, various modules and units included in the various modules included in the first control apparatus of embodiments of the present disclosure can be realized by the processor of the computer device or a certain logic circuit. In an implementation process, the processor can include a Central Processing Unit (CPU), a Microprocessor Unit (MPU), a Digital Signal Processor (DSP), or a Field Programmable Gate Array (FPGA).

Embodiments of the present disclosure further provide a computer-readable storage medium. The computer-readable storage medium stores a computer program that, when executed by the processor, causes the processor to implement all the steps of the control method of the first control device and the control method of the second control device. The computer-readable storage medium can be transient or non-transient.

The description of the various embodiments above tends to emphasize the differences between embodiments of the present disclosure, and identical or similar parts of embodiments of the present disclosure can be referred to each other. The descriptions of the above device and storage medium embodiments are similar to the descriptions of the method embodiments above and have similar beneficial effects as the method embodiments. For technical details not disclosed in the device or storage medium embodiments of the present disclosure, reference can be made to the description of method embodiments of the present disclosure.

“One embodiment” or “an embodiment” mentioned throughout the specification means that a specific feature, structure, or characteristic described in embodiments of the present disclosure can be included in at least one embodiment of the present disclosure. Therefore, “in one embodiment” or “in an embodiment” appearing in various places of the specification do not necessarily refer to the same embodiment. Furthermore, these specific features, structures, or characteristics can be combined in one or more embodiments in any suitable manner. In various embodiments of the present disclosure, the numbering of the above steps/processes does not indicate the execution sequence. The execution order of the steps/processes should be determined according to the function and inherent logic of the steps/processes, and should not impose any limitation on the implementation process of embodiments of the present disclosure. The numbering in the above embodiments is merely for description and does not represent the superiority or inferiority of the embodiments.

In the specification, the terms “comprise,” “include,” or any of their variations are intended to cover non-exclusive inclusion, so that a process, method, article, or apparatus that includes a series of elements not only includes those elements but can also include other elements not expressly listed, or elements inherent to such a process, method, article, or apparatus. Without further limitation, an element defined by the phrase “comprising a. .” does not exclude the existence of additional identical elements in the process, method, article, or apparatus that includes the element.

In embodiments provided by the present disclosure, the disclosed devices and methods can be implemented in other ways. The device embodiments described above are merely illustrative. The above are only embodiments of the present disclosure. However, the scope of the present disclosure is not limited to this. Those skilled in the art can easily think of modifications or replacements within the technical scope of the present disclosure, which should be within the scope of the present disclosure.

What is claimed is:

1. A first control device comprising a first video processing module and a first virtual bus module, wherein:
the first video processing module is connected to a first host of a controlled device, are configured to perform inter-device communication, and the second control device is connected to a primary control device;
the first virtual bus module is configured to obtain a first connection signal in response to a connection between the first control device and the first host;
the first video processing module is configured to, in response to the first connection signal, obtain first video data from the first host and send the first video data to the primary control device; and
the first virtual bus module is further configured to, through communication with the second control device, obtain first control data of a second external device for the first video data from the primary control device, and to map a first virtual external device using the first control data to operate the controlled device, wherein the second external device is an external device corresponding to the primary control device.

2. The first control device according to claim 1, further comprising a first network transmission module, wherein the first virtual bus module includes:
a first virtual device module connected to the first host; and
a first data processing module connected to the first network transmission module and configured to obtain the first control data of the second external device for the first video data through the first network transmission module, and parse the first control data to obtain a descriptor of the second external device and transmit the descriptor to the first virtual device module;
wherein the first virtual device module is configured to map the first virtual external device using the descriptor of the second external device and transmit a control instruction to the first host of the controlled device based on the first virtual external device to control and operate the controlled device.

3. The first control device according to claim 1, further comprising a first video output module connected to a first display device of the controlled device and the first video processing module and configured to obtain the first video data from the first video processing module and transmit the first video data to the first display device, wherein:
the first video processing module is further configured to receive first display data sent by the primary control device through the first network transmission module and transmit the first display data to the first video output module; and
the first video output module is further configured to transmit the first display data to the first display device so that the first display device superimposes the first video data and the first display data for display.

4. The first control device according to claim 1, wherein:
the first virtual bus module includes:
a first virtual host module connected to the first external device of the first control device and configured to obtain second control data of the first external device and transmit the second control data to a first virtual device module of the first virtual bus module; and
the first virtual device module is configured to map a second virtual external device using the second control data to operate the controlled device.

5. A second control device comprising:
a second video processing module connected to a second display device of a primary control device; and
a second virtual bus module connected to a second external device of the primary control device, the second control device and a first control device being configured to perform inter-device communication, and the first control device being connected to a controlled device, wherein:
the second video processing module is configured to communicate with the first control device to obtain first video data from the controlled device for the second display device for display; and
the second virtual bus module is configured to obtain first control data of the second external device based on the displayed first video data and send the first control data to the first control device.

6. The second control device according to claim 5,
wherein the second video processing module is further configured to collect first display data from the second display device and send the first display data to the first control device;
the second control device further comprising a second video output module connected to the second display device and the second video processing module and configured to obtain the first video data from the second video processing module and transmit the first video data to the second display device.

7. The second control device according to claim 5, further comprising a second network transmission module, wherein:
the second virtual bus module includes a second data processing module connected to the second network transmission module and a second virtual host module connected to the second external device;
the second virtual host module is configured to obtain first control data of the second external device and transmit the first control data to the second data processing module; and
the second data processing module is configured to encode the first control data and send the encoded first control data to the first control device through the second network transmission module.

8. The second control device according to claim 7, wherein:
the second virtual bus module further includes a second virtual device module;
the second virtual host module is further configured to transmit the first control data to the second virtual device module; and
the second virtual device module is configured to, based on the first control data, map a third virtual external device and display the third virtual external device on the second display device in real-time based on an operation of the third virtual external device for the second video processing module to collect display data.

9. A control method applied to a first control device comprising:
obtaining a first connection signal in response to a connection between the first control device and a first host of a controlled device;
in response to the first connection signal, obtaining first video data from the first host and sending the first video data to a primary control device; and
obtaining first control data of a second external device for the first video data by communicating with a second control device of the primary control device, and mapping a first virtual external device using the first control data to operate a controlled device.

10. The method according to claim 9, wherein obtaining the first control data of the second external device for the first video data by communicating with the second control device of the primary control device, and mapping the first virtual external device using the first control data to operate the controlled device includes:
obtaining, by communicating with the second control device of the primary control device, first control data of the second external device for the first video data from the primary control device;
parsing the first control data to obtain a descriptor of the second external device; and
mapping the first virtual external device by using the descriptor of the second external device and transmitting a control instruction to a first host of the controlled device based on the first virtual external device to control and operate the controlled device.

11. The method according to claim 9, wherein the first control device includes a first video processing module and a first virtual bus module, wherein:
the first video processing module is connected to the first host of the controlled device, the first virtual bus module is connected to the first host of the controlled device, the second control device are configured to perform inter-device communication, and the second control device is connected to the primary control device;
the second external device is an external device corresponding to the primary control device.

12. The method according to claim 11, wherein:
the first control device further includes a first network transmission module; and
the first virtual bus module includes:
a first virtual device module connected to the first host; and
a first data processing module connected to the first network transmission module.

13. The method according to claim 9, wherein:
the first control device further includes a first video output module connected to a first display device of the controlled device and the first video processing module and configured to obtain the first video data from the first video processing module and transmit the first video data to the first display device;
the first video processing module is further configured to receive first display data sent by the primary control device through the first network transmission module and transmit the first display data to the first video output module; and
the first video output module is further configured to transmit the first display data to the first display device so that the first display device superimposes the first video data and the first display data for display.

14. The method according to claim 9, wherein:
the first virtual bus module includes:
a first virtual host module connected to the first external device of the first control device and configured to obtain second control data of the first external device and transmit the second control data to a first virtual device module of the first virtual bus module; and
the first virtual device module is configured to map a second virtual external device using the second control data to operate the controlled device.

15. The method according to claim 9, wherein the second control device includes:
a second video processing module connected to a second display device of the primary control device; and
a second virtual bus module connected to the second external device of the primary control device, and the first control device being connected to the controlled device.

16. The method according to claim 15, wherein:
the second video processing module is configured to communicate with the first control device; and
the second virtual bus module is configured to obtain the first control data of the second external device based on the displayed first video data and send the first control data to the first control device.

17. The method according to claim 16, wherein:
the second video processing module is further configured to collect first display data from the second display device and send the first display data to the first control device; and
the second control device further includes a second video output module connected to the second display device and the second video processing module and configured to obtain the first video data from the second video processing module and transmit the first video data to the second display device.

18. The method according to claim 15, wherein:
the second control device further includes a second network transmission module;
the second virtual bus module includes a second data processing module connected to the second network transmission module and a second virtual host module connected to the second external device;
the second virtual host module is configured to obtain first control data of the second external device and transmit the first control data to the second data processing module; and
the second data processing module is configured to encode the first control data and send the encoded first control data to the first control device through the second network transmission module.

19. The method according to claim 18, wherein:
the second virtual bus module further includes a second virtual device module; and
the second virtual host module is further configured to transmit the first control data to the second virtual device module.

20. The method according to claim 19, wherein:
the second virtual device module is configured to, based on the first control data, map a third virtual external device and display the third virtual external device on the second display device in real-time based on an operation of the third virtual external device for the second video processing module to collect display data.
